(19) United States
(12) Patent Application Publication
(10) Pub. No.: US 2026/0008902 A1
(43) Pub. Date: Jan. 8, 2026

(54) STABILIZING A SHAPED POLYMER ARTICLE AGAINST DEGRADATION INDUCED BY ARTIFICIAL UV-C LIGHT

(71) Applicant: BASE SE, Ludwigshafen am Rhein (DE)

(72) Inventors: Michèle GERSTER, Basel (CH); Tania WEYLAND, Kaisten (CH); Gregor HUBER, Tarrytown, NY (US); Jean-Roch PAUQUET, Kaisten (CH); Daniel MUELLER, Kaisten (CH); Heinz HERBST, Kaisten (CH)

(21) Appl. No.: 18/880,242

(22) PCT Filed: Jun. 19, 2023
(86) PCT No.: PCT/EP2023/066358

§ 371 Date: Dec. 30, 2024

(30) Foreign Application Priority Data
Jun. 29, 2022 (EP) 22181926.1

(51) Int. Cl. C08K 5/3492; C08K 5/132; C08K 5/20; C08K 5/315; C08K 5/3475

(52) U.S. Cl. CPC C08K 5/3492; C08K 5/132; C08K 5/20; C08K 5/315; C08K 5/3475

(57) ABSTRACT

The present invention relates to a use of a stabilizer selected from compound (1) to (7), a mixture of compound (8) and a hydroxyphenyltriazine selected from compounds (10), (11) or (12), a mixture of compound (9) and a hydroxyphenyltriazine selected from compounds (10), (11) or (12) for stabilizing a shaped polymer article against degradation induced by artificial UV-C light; and to a method for stabilizing a shaped polymer article against degradation induced by artificial UV-C light, which comprises incorporating into the shaped polymer articles a stabilizer selected from the stabilizers.

Stabilizing a shaped polymer article against degradation induced by artificial UV-C light

The present invention relates to a use of a stabilizer selected from compound (1) to (7), a mixture of compound (8) and a hydroxyphenyltriazine selected from compounds (10), (11) or (12), a mixture of compound (9) and a hydroxyphenyltriazine selected from compounds (10), (11) or (12) for stabilizing a shaped polymer article against degradation induced by artificial UV-C light; and to a method for stabilizing a shaped polymer article against degradation induced by artificial UV-C light, which comprises incorporating into the shaped polymer articles a stabilizer selected from the stabilizers. Combinations of preferred embodiments with other preferred embodiments are within the scope of the present invention.

Artificial UV-C light is increasingly used for disinfection of polymer articles. As a result an increase of yellowing, microcracks, or blooming was observed in such polymer articles. Thus, there is a need for the development of suitable plastic additives which offer a low application rate, which are compatible with other plastic additives, and which reduce yellowing, microcracks, or blooming.

The objects were achieved by a use of a stabilizer selected from

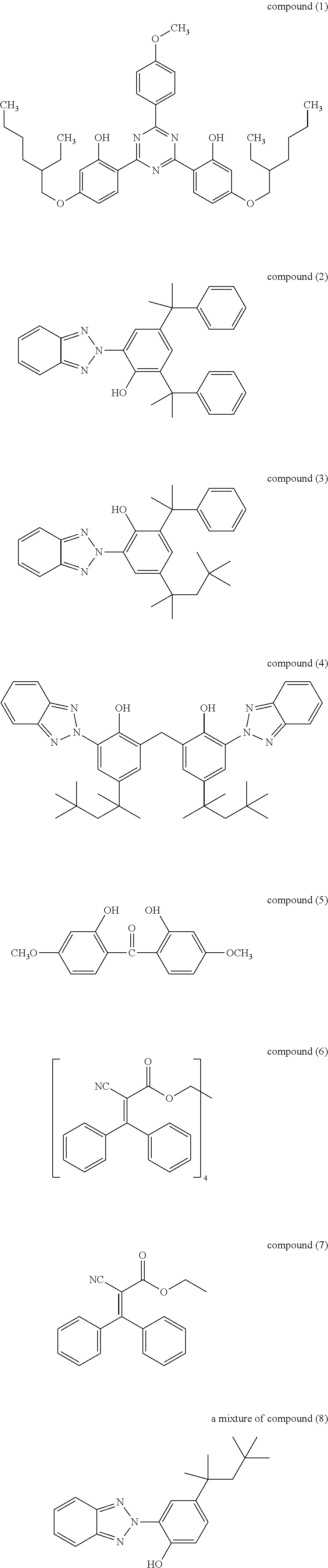

and a hydroxyphenyltriazine selected from compounds (10), (11) or (12)

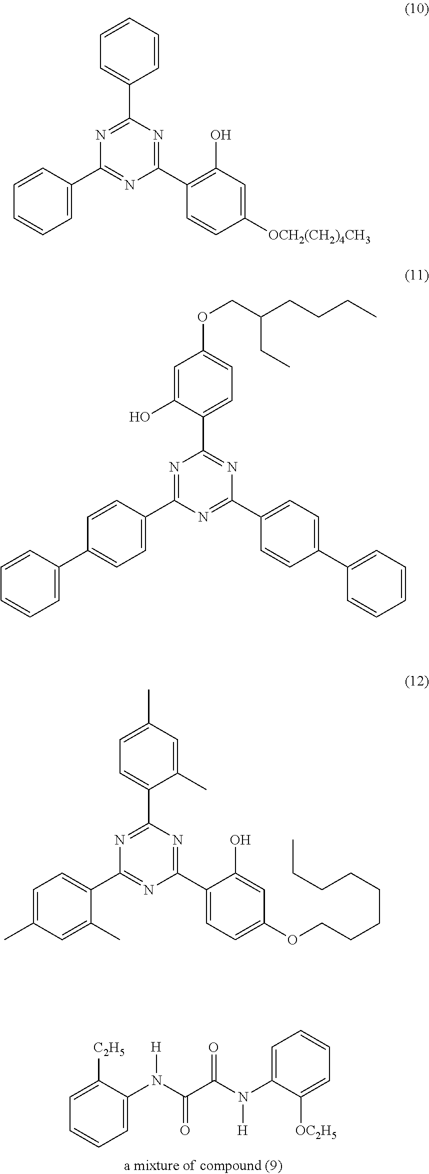

and a hydroxyphenyltriazine selected from compound (10), (11) or (12)
for stabilizing a shaped polymer article against degradation induced by artificial UV-C light.

The objects were also achieved by a method for stabilizing a shaped polymer article against degradation induced by artificial UV-C light, which comprises incorporating into the shaped polymer articles the stabilizer.

In a preferred form the stabilizer is selected from compound (1).

In another preferred form the stabilizer is selected from compound (2).

In another preferred form the stabilizer is selected from compound (3).

In another preferred form the stabilizer is selected from compound (4).

In another preferred form the stabilizer is selected from compound (5).

In another preferred form the stabilizer is selected from compound (6).

In another preferred form the stabilizer is selected from compound (7).

In another preferred form the stabilizer is selected from compounds (1), (2), (3), (4), (5), (6), or (7).

In another preferred form the stabilizer is selected from compounds (2), (3), or (4).

In another preferred form the stabilizer is selected from compounds (6) or (7).

Mixtures of the stabilizers selected from compounds (1), (2), (3), (4), (5), (6), or (7) are also possible. Usually, a mixture of these stabilizers comprises two of the stabilizers. A mixture of two stabilizers selected from compounds (1), (2), (3), (4), (5), (6), or (7) may comprise them in a weight ratio of from 10:1 to 1:10, preferably from 7:1 to 1:7.

In another preferred form the stabilizer is selected from a mixture of compound (1) and a further stabilizer selected from compounds (2) to (7), and where the weight ratio can be from 10:1 to 1:10, preferably from 7:1 to 1:7.

In another preferred form the stabilizer is selected from a mixture of compound (2) and a further stabilizer selected from compounds (1) or (3) to (7), and where the weight ratio can be from 10:1 to 1:10, preferably from 7:1 to 1:7.

In another preferred form the stabilizer is selected from a mixture of compound (3) and a further stabilizer selected from compounds (1) to (2) or (4) to (7), and where the weight ratio can be from 10:1 to 1:10, preferably from 7:1 to 1:7.

In another preferred form the stabilizer is selected from a mixture of compound (4) and a further stabilizer selected from compounds (1) to (3) or (5) to (7), and where the weight ratio can be from 10:1 to 1:10, preferably from 7:1 to 1:7.

In another preferred form the stabilizer is selected from a mixture of compound (5) and a further stabilizer selected from compounds (1) to (4) or (6) to (7), and where the weight ratio can be from 10:1 to 1:10, preferably from 7:1 to 1:7.

In another preferred form the stabilizer is selected from a mixture of compound (6) and a further stabilizer selected from compounds (1) to (5) or (7), and where the weight ratio can be from 10:1 to 1:10, preferably from 7:1 to 1:7.

In another preferred form the stabilizer is selected from a mixture of compound (7) and a further stabilizer selected from compounds (1) to (6), and where the weight ratio can be from 10:1 to 1:10, preferably from 7:1 to 1:7.

In another preferred form the stabilizer is selected from
a mixture of compound (7) and compound (11),
a mixture of compound (5) and compound (11),
a mixture of compound (2) and compound (10),
a mixture of compound (2) and compound (11),
a mixture of compound (3) and compound (11)
a mixture of compound (4) and compound (11), or
a mixture of compound (6) and compound (11).

In another preferred form the stabilizer is selected from the mixture of compound (8) and the hydroxyphenyltriazine selected from compounds (10), (11) or (12).

In another preferred form the stabilizer is selected from the mixture of compound (9) and the hydroxyphenyltriazine selected from compounds (10), (11) or (12).

In another preferred form the stabilizer is selected from the mixture of compound (8) and the hydroxyphenyltriazine selected from compounds (10), (11) or (12), where the weight ratio is from 100:1 to 1:3, preferably from 50:1 to 2:1.

In another preferred form the stabilizer is selected from the mixture of compound (9) and the hydroxyphenyltriazine selected from compounds (10), (11) or (12), where the weight ratio is from 100:1 to 1:3, preferably from 50:1 to 2:1.

In another preferred form the stabilizer is selected from
the mixture of compound (8) and at least one of compounds (10), (11) or (12); and
the mixture of compound (9) and at least one of compounds (10), (11) or (12).

In another preferred form the stabilizer is selected from
the mixture of compound (8) and one of compounds (10), (11) or (12); and
the mixture of compound (9) and one of compounds (10), (11) or (12).

In another preferred form the stabilizer is selected from
the mixture of compound (8) and one of compounds (10), (11) or (12), where the weight ratio is from 100:1 to 1:3, preferably from 50:1 to 2:1.; or
the mixture of compound (9) and one of compounds (10), (11) or (12) where the weight ratio is from 100:1 to 1:3, preferably from 50:1 to 2:1.

In another preferred form the stabilizer is selected from
the mixture of compound (8) and compound (10); and
the mixture of compound (9) and compound (10).

In another preferred form the stabilizer is selected from
the mixture of compound (8) and compound (11); and
the mixture of compound (9) and compound (11).

In another preferred form the stabilizer is selected from
the mixture of compound (8) and compound (12); and
the mixture of compound (9) and compound (12).

In another preferred form the stabilizer is selected from a mixture of compound (8) and compound (10).

In another preferred form the stabilizer is selected from a mixture of compound (8) and compound (11).

In another preferred form the stabilizer is selected from a mixture of compound (8) and compound (12).

In another preferred form the stabilizer is selected from a mixture of compound (9) and compound (10).

In another preferred form the stabilizer is selected from a mixture of compound (9) and compound (11).

In another preferred form the stabilizer is selected from a mixture of compound (9) and compound (12).

In another preferred form the stabilizer is selected from
a mixture of compound (8) and compound (10),
a mixture of compound (8) and compound (11), or
a mixture of compound (9) and compound (12).

In another preferred form the stabilizer is selected from a mixture of compound (8) and compound (10), where the weight ratio is from 30:1 to 1:1, preferably from 20:1 to 3:1.

In another preferred form the stabilizer is selected from a mixture of compound (8) and compound (11), where the weight ratio is from 30:1 to 1:1, preferably from 20:1 to 3:1.

In another preferred form the stabilizer is selected from a mixture of compound (8) and compound (12), where the weight ratio is from 30:1 to 1:1, preferably from 20:1 to 3:1.

In another preferred form the stabilizer is selected from a mixture of compound (9) and compound (10), where the weight ratio is from 30:1 to 1:1, preferably from 20:1 to 3:1.

In another preferred form the stabilizer is selected from a mixture of compound (9) and compound (11), where the weight ratio is from 30:1 to 1:1, preferably from 20:1 to 3:1.

In another preferred form the stabilizer is selected from a mixture of compound (9) and compound (12), where the weight ratio is from 30:1 to 1:1, preferably from 20:1 to 3:1.

The shaped polymer article comprises usually 0.01-5 wt %, preferably 0.1-3 wt % of each of the stabilizers.

The shaped polymer article comprises usually a total amount of the stabilizers of 0.01-5 wt %, preferably 0.1-3 wt %.

The stabilizer is usually present inside the shaped polymer article, e.g. it is evenly distributed inside the shaped polymer article. In another form the stabilizer is usually incorporated in the shaped polymer article, e.g. it is evenly incorporated the shaped polymer article.

The artificial UV-C light can have a wavelength from 100 to 290 nm, preferably from 200 to 275 nm. For example the UV-C light has a wavelength of 250-260 nm, or 220-230 nm, or 210-220 nm, or 260-270 nm, or 200-220 nm.

The UV-C light is artificial, which usually means it is produced by lamps, such as mercury lamps, excimer lamps, pulsed xenon lamps, or light-emitting diodes (LED).

The degradation is usually induced by UV-C disinfection against microorganisms of the shaped polymer article. UV-C disinfection is a method to disinfect a surface by irradiating it with the artificial UV-C light.

The UV-C disinfection typically results in a decrease of microorganism, such as archaea, bacteria, fungi, protozoa, or viruses. When a microorganism is exposed to UV-C light, the nuclei of the cells can be modified due to photolytic processes. In result, cell division and, by extension, reproduction can be prevented.

Examples of bacteria are the following genus: Chlamydia, Clostridium, Escherichia, Helicobacterium, Lactobacillus, Legionella, Leuconostoc, Listeria, Pediococcus, Salmonella, Shigella, Staphylococcus, Vibrio and Yersinia.

Examples of fungi are the following genus: Aspergillus, Penicillium, Saccharomyces and Candida.

Examples of viruses are the following genus and groups: Coronavirus (e.g. SARS-COV-1 (severe acute respiratory syndrome coronavirus), MERS-COV (Middle East respiratory syndrome coronavirus), SARS-COV-2), Rotavirus, Norovirus, Human papilloma virus, Herpes virus, Hepatitis virus, Influenza virus and HIV.

UV-C disinfection of surfaces requires usually a high intensity of UV-C light and the lamps are typically close to the surface which are kept free from microorganisms.

The dose of the UV-C light usually determines the effectiveness of the UV-C disinfection. The dose is the product of UV intensity (expressed as energy per unit surface area, e.g. micro Watt per cm2) and exposure time (e.g. seconds). The dose is commonly expressed as 1mJ/cm2=1000 micro Watt second/cm2.

Doses for a 90% kill of most bacteria and viruses range according to literature usually between 2,000 and 8,000 μW·s/cm2. Some typical doses (mJ/cm2) can be found in literature to control some microorganisms:

| | |
|---|---|
| Bacillus subtilis (spore) | 12.0 |
| Clostridium tetani | 4.9 |
| Legionella Pneumophilla | 2.04 |
| Pseudonomas aeruginosa | 5.5 |
| Streptococcus feacalis | 4.5 |
| Hepatitis A virus | 11.0 |
| Hepatitis Poliovirus | 12.0 |
| Saccharomyces cervisiae | 6.0 |
| Infectious pancreatic necrosis | 60.0 |

In general a dose of the UV-C light of at least 100, 500, 1000, 1500, 2000, 3000, or 5000 μW·s/cm2 within 24 h is received at the surface of the shaped polymer article. For example the surface receives each day a dose of at least 500 μW·s/cm2, such as a surface in a subway, which is disinfected with UV-C light each early morning, or a surface in a taxi, which is disinfected with doses of UV-C light after each passenger in a day.

The degradation by UV-C light, preferably induced by UV-C disinfection, is usually induced frequently, for example at least once a second, a minute, an hour, a day, or a week. The term “frequently” usually means in certain time intervalls.

The degradation by UV-C light is usually induced indoors, such as in public buildings (e.g. schools, hospitals, libraries), industrial offices (open plan offices, cubicles), industrial production buildings (warehouses, assembly halls), private buildings (single family houses, multistory houses, skyscraper), or in transport vehicles (cars, taxis, bus, trams, underground railway, trains, airplanes, ships). Preferably, the degradation by UV-C light is induced indoors in public buildings or in transport vehicles.

The shaped polymer articles is usually an articles which is present indoors, such as in public buildings (e.g. schools, hospitals, libraries), industrial offices (open plan offices, cubicles), industrial production buildings (warehouses, assembly halls), private buildings (single family houses, multistory houses, skyscraper), or in transport vehicles (cars, taxis, bus, trams, underground railway, trains, airplanes, ships). Preferably, the shaped polymer article is present indoors in public buildings or in transport vehicles.

Suitable shaped polymer articles are:
Articles in transport vehicles, e.g. dashboards, hat shelf, seats, trunk linings, interior linings, panes for dashboards, instrument panel, upholstery, door panels, seat backing, pillar covers, fasteners, consoles, instrument panels, seats, frames, skins;
Appliances, e.g. cases and coverings in general, electronic devices (personal computer, telephone, portable phone, printer, television-sets, audio and video devices), or electric appliances, (e.g. washing machines, tumblers, ovens (microwave oven), dish-washers, mixers, and irons);
Sanitary articles, e.g. mobile toilets, shower cubicles, lavatory seats, covers, sinks, shower curtains, brushes, mats, tubs, mobile toilets, tooth brushes, and bed pans;
Fabrics, e.g. carpets, curtains, shades, nets, ropes, cables, strings, cords, threads, clothes, underwear, gloves, shoes, sportswear, umbrellas, tents, airbeds, bags;
Storage systems such as boxes (crates), luggage, bottles, chest, household boxes, pallets, container, shelves, tracks, screw boxes, packs, and cans.
Medical devices such as piston, plastic syringes, ophthalmic applications, diagnostic devices, and packing for pharmaceuticals blister.
Furniture, e.g. foamed articles (cushions, impact absorbers), dish clothes, mats, chairs, tables, couches;
Office supplies, e.g. ball-point pens, ink-pads, mouse, shelves, tracks.

Preferably, the shaped polymer article is an article in transport vehicles or a medical device.

The shaped polymer article is usually a non-transparent article.

The shaped polymer article has usually at least in part a non-porous surface.

In general a non-porous surface of the shaped polymer article is stabilized against the degradation.

Typically, a non-transparent surface of the shaped polymer article is stabilized against the degradation.

The stabilizing against degradation usually comprises
a reduction of yellowing of the shaped article, or
a reduction of microcracks on the surface of the shaped article, or
a reduction of blooming of the shaped article.

The reduction may be determined in comparison to a shaped polymer article which is free of the stabilizer. The stabilizer may stabilize the area of the shaped article which is exposed to the UV-C light.

The shaped polymer articles is usually made of a synthetic polymer. Examples of synthetic polymer are:
1. Polymers of monoolefins and diolefins, for example polypropylene, polyisobutylene, polybut-1-ene, poly-4-methylpent-1-ene, polyvinylcyclohexane, polyisoprene or poly-butadiene, polyhexene, polyoctene, as well as polymers of cycloolefins, for instance of cyclopentene, cyclohexene, cyclooctene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or ρ-coordinated. These metal complexes may be in the free form or fixed on substrates, typically on activated magnesium chloride, titanium (III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single-site catalysts (SSC).
2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
3. Copolymers of monoolefins and diolefins with each other or with other vinyl monomers, for example ethylene/propylene copolymers, linear low density polyethylene (LLDPE) and mixtures thereof with low density polyethylene (LDPE), very low density polyethylene, propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
4. Hydrocarbon resins (for example C5-C9) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included. Copolymers from 1.)-4.) may by random or block-copolymers, homo-or heterophasic, or High Crystalline Homopolymer.
5. Polystyrene, poly(p-methylstyrene), poly(α-methylstyrene).
6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.
6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/isoprene/butadiene/styrene, styrene/ethylene/butylene/styrene or styrene/ethylene/propylene/styrene, HIPS, ABS, ASA, AES.
6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).
6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.
7. Graft copolymers of vinyl aromatic monomers such as styrene or-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on poly(alkyl acrylates) or poly(alkyl methacrylates), styrene and acrylonitrile on acrylate/butadiene copolymers, as well as mixtures thereof with the copolymers listed under 6), for example the copolymer mixtures known as ABS, MBS, ASA or AES polymers.
8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo-and copolymers, especially polymers of halogen-containing vinyl compounds, for example polyvinyl chloride (PVC), polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers. Polyvinyl chloride may be rigid or flexible (plasticized).
9. Polymers derived from α,β-unsaturated acids and derivatives thereof such as polyacrylates and polymethacrylates; poly(methyl methacrylates), polyacrylamides and polyacrylonitriles, impact-modified with butyl acrylate.
10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.
11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.
12. Homopolymers and copolymers of cyclic ethers such as polyalkylene glycols, polyethylene oxide, polypropylene oxide or copolymers thereof with bisglycidyl ethers.
13. Polyacetals such as polyoxymethylene and those polyoxymethylenes which contain ethylene oxide as a comonomer; polyacetals modified with thermoplastic polyurethanes, acrylates or MBS.
14. Polyphenylene oxides and sulfides, and mixtures of polyphenylene oxides with styrene polymers or polyamides.
15. Polyurethanes derived from hydroxyl-terminated polyethers, polyesters or polybutadienes on the one hand and aliphatic or aromatic polyisocyanates on the other, as well as precursors thereof. Polyurethanes formed by the reaction of: (1) diisocyanates with short-chain diols (chain extenders) and (2) diisocyanates with long-chain diols (thermoplastic polyurethanes, TPU).
16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems). The poylamides may be amorphous.
17. Polyureas, polyimides, polyamideimides, polyetherimides, polyesterimides, polyhydantoins and polybenzimidazoles.
18. Polyesters derived from dicarboxylic acids and diols and/or from hydroxycarboxylic acids or the corresponding lactones or lactides, for example polyethylene terephthalate (PET), polybutylene terephthalate, poly-1,4-dimethylolcyclohexane terephthalate, polypropylene terephthalate, polyalkylene naphthalate and polyhydroxybenzoates as well as copolyether esters derived from hydroxyl-terminated polyethers, and also polyesters modified with polycarbonates or MBS. Copolyesters may comprise, for example—but are not limited to—polybutyl-enesuccinate/terephtalate, polybutyleneadipate/terephthalate, polytetramethylenead-ipate/terephthalate, polybutylensuccinate/adipate, polybutylensuccinate/carbonate, poly-3-hydroxybutyrate/octanoate copolymer, poly-3-hydroxybutyrate/hexanoate/decanoate terpolymer. Furthermore, aliphatic polyesters may comprise, for example—but are not limited to—the class of poly(hydroxyalkanoates), in particular, poly(propiolactone), poly(butyrolactone), poly(pivalolactone), poly(valerolactone) and poly(caprolactone), polyethylenesuccinate, polypropylenesuccinate, polybutylenesuccinate, polyhexamethylenesuccinate, polyethyleneadipate, polypropyleneadipate, polybutyleneadipate, polyhexamethyleneadipate, polyethyleneoxalate, polypropyleneoxalate, polybutyleneoxalate, polyhexamethyleneoxalate, polyethylenesebacate, polypropylenesebacate, polybutylenesebacate, polyethylene furanoate and polylactic acid (PLA) as well as corresponding polyesters modified with polycarbonates or MBS. The term “polylactic acid (PLA)” designates a homo-polymer of preferably poly-L-lactide and any of its blends or alloys with other polymers; a co-polymer of lactic acid or lactide with other monomers, such as hydroxy-carboxylic acids, like for example glycolic acid, 3-hydroxy-butyric acid, 4-hydroxy-butyric acid, 4-hydroxy-valeric acid, 5-hydroxy-valeric acid, 6-hydroxy-caproic acid and cyclic forms thereof; the terms “lactic acid” or “lactide” include L-lactic acid, D-lactic acid, mixtures and dimers thereof, i.e. L-lactide, D-lactide, meso-lactide and any mixtures thereof. Preferred polyesters are PET, PET-G, PBT.
19. Polycarbonates and polyester carbonates. The polycarbonates are preferably prepared by reaction of bisphenol compounds with carbonic acid compounds, in particular phosgene or, in the melt transesterification process, diphenyl carbonate or dimethyl carbonate. Homopolycarbonates based on bisphenol A and copolycarbonates based on the monomers bisphenol A and 1,1-bis-(4-hydroxyphenyl)-3,3,5-trimethylcyclohexane (bisphenol TMC) are particularly preferred. These and further bisphenol and diol compounds which can be used for the polycarbonate synthesis are disclosed inter alia in WO08037364 (p. 7, line 21 to p. 10, line 5), EP1582549 ([0018] to [0034] ), WO02026862 (p.2, line 23 to p.-5, line 15), WO05113639 (p. 2, line 1 to p.7, line 20). The polycarbonates can be linear or branched. Mixtures of branched and unbranched polycarbonates can also be used. Suitable branching agents for polycarbonates are known from the literature and are described, for example, in patent specifications U.S. Pat. No. 4,185,009 and DE2500092 (3,3-bis-(4-hydroxyaryl-oxindoles according to the invention, see whole document in each case), DE4240313 (see p.3, line 33 to 55), DE19943642 (see p.5, line 25 to 34) and U.S. Pat. No. 5,367,044 as well as in literature cited therein. The polycarbonates used can additionally be intrinsically branched, no branching agent being added here within the context of the polycarbonate preparation. An example of intrinsic branchings are so-called Fries structures, as are disclosed for melt polycarbonates in EP1506249. Chain terminators can additionally be used in the polycarbonate preparation. Phenols such as phenol, alkylphenols such as cresol and 4-tert-butylphenol, chlorophenol, bromophenol, cumylphenol or mixtures thereof are preferably used as chain terminators. Polyester carbonates are obtained by reaction of the bisphenols already mentioned, at least one aromatic dicarboxylic acid and optionally carbonic acid equivalents. Suitable aromatic dicarboxylic acids are, for example, phthalic acid, terephthalic acid, isophthalic acid, 3,3′- or 4,4′-diphenyldicarboxylic acid and benzophenone-dicarboxylic acids. A portion, up to 80 mol-%, preferably from 20 to 50 mol-%, of the carbonate groups in the polycarbonates can be replaced by aromatic dicarboxylic acid ester groups.
20. Polyketones.
21. Polysulfones, polyether sulfones and polyether ketones.
22. Crosslinked polymers derived from aldehydes on the one hand and phenols, ureas and melamines on the other hand, such as phenol/formaldehyde resins, urea/formaldehyde resins and melamine/formaldehyde resins.
23. Drying and non-drying alkyd resins.
24. Unsaturated polyester resins derived from copolyesters of saturated and unsaturated dicarboxylic acids with polyhydric alcohols and vinyl compounds as crosslinking agents, and also halogen-containing modifications thereof of low flammability.
25. Crosslinkable acrylic resins derived from substituted acrylates, for example epoxy acrylates, urethane acrylates or polyester acrylates.
26. Alkyd resins, polyester resins and acrylate resins crosslinked with melamine resins, urea resins, isocyanates, isocyanurates, polyisocyanates or epoxy resins.
27. Crosslinked epoxy resins derived from aliphatic, cycloaliphatic, heterocyclic or aromatic glycidyl compounds, e.g. products of diglycidyl ethers of bisphenol A, bisphenol E and bisphenol F, which are crosslinked with customary hardeners such as anhydrides or amines, with or without accelerators.
28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.
29. Blends of the aforementioned polymers (polyblends), for example PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and co-polymers, PA/HDPE, PA/PP, PA/PPO, PBT/PC/ABS or PBT/PET/PC.
30. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.
31. Aqueous emulsions of natural or synthetic rubber, e.g. natural latex or latices of carboxylated styrene/butadiene copolymers.
32. Adhesives, for example block copolymers such as SIS, SBS, SEBS, SEPS (S represents styrene, I isoprene, B polybutadiene, EB ethylene/butylene block, EP polyethylene/polypropylene block).
33. Rubbers, for example polymers of conjugated dienes, e.g. polybutadiene or polyisoprene, copolymers of mono- and diolefins with one another or with other vinyl monomers, copolymers of styrene or α-methylstyrene with dienes or with acrylic derivatives, chlorinated rubbers, natural rubber.
34. Elastomers, for example natural polyisoprene (cis-1,4-polyisoprene natural rubber (NR) and trans-1,4-polyisoprene gutta-percha), Synthetic polyisoprene (IR for isoprene rubber), Polybutadiene (BR for butadiene rubber), Chloroprene rubber (CR), polychloroprene, Neoprene, Baypren etc., Butyl rubber (copolymer of isobutylene and isoprene, IIR), Halogenated butyl rubbers (chloro butyl rubber: CIIR; bromo butyl rubber: BIIR), Styrene-butadiene Rubber (copolymer of styrene and butadiene, SBR), Nitrile rubber (copolymer of butadiene and acrylonitrile, NBR), also called Buna N rubbers Hydrogenated Nitrile Rubbers (HNBR) Therban and Zetpol, EPM (ethylene propylene rubber, a copolymer of ethylene and propylene) and EPDM rubber (ethylene propylene diene rubber, a terpolymer of ethylene, propylene and a diene-component), Epichlorohydrin rubber (ECO), Polyacrylic rubber (ACM, ABR), Silicone rubber (SI, Q, VMQ), Fluorosilicone Rubber (FVMQ), Fluoroelastomers (FKM, and FEPM) Viton, Tecnoflon, Fluorel, Aflas and Dai-El, Perfluoroelastomers (FFKM) Tecnoflon PFR, Kalrez, Chemraz, Perlast, Polyether block amides (PEBA), Chlorosulfonated polyethylene (CSM), (Hypalon), Ethylene-vinyl acetate (EVA), Thermoplastic elastomers (TPE), The proteins resilin and elastin, Polysulfide rubber, Elastolefin, elastic fiber used in fabric production.
35. Thermoplastic elastomers, for example Styrenic block copolymers (TPE-s), Thermoplastic olefins (TPE-o), Elastomeric alloys (TPE-v or TPV), Thermoplastic polyurethanes (TPU),

Thermoplastic copolyester, Thermoplastic polyamides, Reactor TPO's (R-TPO's), Polyolefin Plastomers (POP's), Polyolefin Elastomers (POE's).

Preferred synthetic polymers are polymers of above classes 1, 5, 6, 6a, 6b, 6c, 7, 8, 16, 18 and 19.

In another preferred form the synthetic polymers are polyethylenes, polypropylenes, polystyrenes, acrylonitrile butadiene styrene copolymer, or polycarbonates.

In another preferred form the synthetic polymers are polyethylenes, polypropylenes, polystyrenes, acrylonitrile butadiene styrene copolymer, polycarbonates, polyvinyl chlorides, polyamides, polyurethanes, poly(methyl methacrylates) or polyethylene terephthalates.

In another preferred form the synthetic polymers are polyethylenes, polypropylenes, poly(methyl methacrylates), polystyrenes, acrylonitrile butadiene styrene copolymer, polycarbonates, polyvinyl chlorides, polyamides, polyurethanes, or polyethylene terephthalates.

In another preferred form the synthetic polymers are polyethylenes, polypropylenes, acrylonitrile butadiene styrene copolymer, polyurethanes, poly(methyl methacrylates).

In another preferred form the synthetic polymers are polyethylenes.

In another preferred form the synthetic polymers are polypropylenes.

In another preferred form the synthetic polymers are polystyrenes

In another preferred form the synthetic polymers are acrylonitrile butadiene styrene copolymer.

In another preferred form the synthetic polymers are polycarbonates.

In another preferred form the synthetic polymers are polyvinyl chlorides.

In another preferred form the synthetic polymers are polyamides.

In another preferred form the synthetic polymers are polyethylene terephthalates.

In another preferred form the synthetic polymers are polyurethanes.

In another preferred form the synthetic polymers are poly(methyl methacrylates).

Preferably, the synthetic polymers are polypropylenes or polyvinyl chloride, and the shaped article is an article in transport vehicle, such as a dashboard.

In another preferred form, the synthetic polymers are polyurethanes and the shaped article is an article in transport vehicle, such as a steering wheel.

In another preferred form, the synthetic polymers are polyethylene terephthalates and the shaped article is an article in transport vehicle, such as a fiber for upholstery or interior linings.

In another preferred form the stabilizer is compound (2) and the shaped polymer article is made of a polyolefin, such as a polypropylene.

In another preferred form the stabilizer is compound (2) and the shaped polymer article is made of a polyolefin, such as a polypropylene, and the shaped polymer article comprises 0.01-1 wt %, preferably 0.01-0.5 wt % of the stabilizer.

In another preferred form the stabilizer is compound (1) and the shaped polymer article is made of an acrylonitrile butadiene styrene copolymer.

In another preferred form the stabilizer is compound (2) and the shaped polymer article is made of an acrylonitrile butadiene styrene copolymer.

In another preferred form the stabilizer is compound (4) and the shaped polymer article is made of an acrylonitrile butadiene styrene copolymer.

In another preferred form the stabilizer is compound (6) and the shaped polymer article is made of an acrylonitrile butadiene styrene copolymer.

In another preferred form the stabilizer is compound (1) and the shaped polymer article is made of an acrylonitrile butadiene styrene copolymer and the shaped polymer article comprises 0.01-1 wt %, preferably 0.01-0.5 wt % of the stabilizer.

In another preferred form the stabilizer is compound (2) and the shaped polymer article is made of an acrylonitrile butadiene styrene copolymer and the shaped polymer article comprises 0.01-1 wt %, preferably 0.01-0.5 wt % of the stabilizer.

In another preferred form the stabilizer is compound (4) and the shaped polymer article is made of an acrylonitrile butadiene styrene copolymer and the shaped polymer article comprises 0.01-1 wt %, preferably 0.01-0.5 wt % of the stabilizer.

In another preferred form the stabilizer is compound (6) and the shaped polymer article is made of an acrylonitrile butadiene styrene copolymer and the shaped polymer article comprises 0.01-1 wt %, preferably 0.01-0.5 wt % of the stabilizer.

In another preferred form the stabilizer is a mixture of compound (1) and compound (13), and the shaped polymer article is made of an acrylonitrile butadiene styrene copolymer.

In another preferred form the stabilizer is a mixture of compound (2) and compound (13), and the shaped polymer article is made of an acrylonitrile butadiene styrene copolymer.

In another preferred form the stabilizer is a mixture of compound (4) and compound (13), and the shaped polymer article is made of an acrylonitrile butadiene styrene copolymer.

In another preferred form the stabilizer is a mixture of compound (6) and compound (13), and the shaped polymer article is made of an acrylonitrile butadiene styrene copolymer.

In another preferred form the stabilizer is a mixture of compound (1) and compound (13), and the shaped polymer article is made of an acrylonitrile butadiene styrene copolymer, and where the weight ratio is from 10:1 to 1:10, 5:1 to 1:5, or 3:1 to 1:3.

In another preferred form the stabilizer is a mixture of compound (2) and compound (13), and the shaped polymer article is made of an acrylonitrile butadiene styrene copolymer, and where the weight ratio is from 10:1 to 1:10, 5:1 to 1:5, or 3:1 to 1:3.

In another preferred form the stabilizer is a mixture of compound (4) and compound (13), and the shaped polymer article is made of an acrylonitrile butadiene styrene copolymer, and where the weight ratio is from 10:1 to 1:10, 5:1 to 1:5, or 3:1 to 1:3.

In another preferred form the stabilizer is a mixture of compound (6) and compound (13), and the shaped polymer article is made of an acrylonitrile butadiene styrene copolymer, and where the weight ratio is from 10:1 to 1:10, 5:1 to 1:5, or 3:1 to 1:3.

In another preferred form the stabilizer is a mixture of compound (8) and a hydroxyphenyl-triazine selected from compounds (10), (11) or (12), and the shaped polymer article is made of a polyolefin, such as a polyethylene.

In another preferred form the stabilizer is a mixture of compound (8) and compound (10), and the shaped polymer article is made of a polyolefin, such as a polyethylene.

In another preferred form the stabilizer is a mixture of compound (8) and compound (11), and the shaped polymer article is made of a polyolefin, such as a polyethylene.

In another preferred form the stabilizer is a mixture of compound (8) and a hydroxyphenyl-triazine selected from compounds (10), (11) or (12), and the shaped polymer article is made of a polyolefin, such as a polyethylene, and where the weight ratio is from 10:1 to 1:5, or 5:1 to 1:1

In another preferred form the stabilizer is a mixture of compound (8) and compound (10), and the shaped polymer article is made of a polyolefin, such as a polyethylene, and where the weight ratio is from 10:1 to 1:5, or 5:1 to 1:1.

In another preferred form the stabilizer is a mixture of compound (8) and compound (11), and the shaped polymer article is made of a polyolefin, such as a polyethylene, and where the weight ratio is from 10:1 to 1:5, or 5:1 to 1:1.

In another preferred form the stabilizer is compound (3) and the shaped polymer article is made of a polyolefin, such as a polyethylene.

In another preferred form the stabilizer is compound (4) and the shaped polymer article is made of a polyolefin, such as a polyethylene.

In another preferred form the stabilizer is compound (5) and the shaped polymer article is made of a polyolefin, such as a polyethylene.

In another preferred form the stabilizer is compound (7) and the shaped polymer article is made of a polyolefin, such as a polyethylene.

In another preferred form the stabilizer is compound (3) and the shaped polymer article is made of a polyolefin, such as a polyethylene, and the shaped polymer article comprises 0.01-1 wt %, preferably 0.01-0.5 wt % of the stabilizer.

In another preferred form the stabilizer is compound (4) and the shaped polymer article is made of a polyolefin, such as a polyethylene, and the shaped polymer article comprises 0.01-1 wt %, preferably 0.01-0.5 wt % of the stabilizer.

In another preferred form the stabilizer is compound (5) and the shaped polymer article is made of a polyolefin, such as a polyethylene, and the shaped polymer article comprises 0.01-1 wt %, preferably 0.01-0.5 wt % of the stabilizer.

In another preferred form the stabilizer is compound (7) and the shaped polymer article is made of a polyolefin, such as a polyethylene, and the shaped polymer article comprises 0.01-1 wt %, preferably 0.01-0.5 wt % of the stabilizer.

In another preferred form the stabilizer is a mixture of compound (5) and a hydroxyphenyl-triazine selected from compounds (10), (11) or (12), and the shaped polymer article is made of a polyolefin, such as a polyethylene.

In another preferred form the stabilizer is a mixture of compound (7) and a hydroxyphenyl-triazine selected from compounds (10), (11) or (12), and the shaped polymer article is made of a polyolefin, such as a polyethylene.

In another preferred form the stabilizer is a mixture of compound (5) and compound (11), and the shaped polymer article is made of a polyolefin, such as a polyethylene.

In another preferred form the stabilizer is a mixture of compound (7) and compound (11), and the shaped polymer article is made of a polyolefin, such as a polyethylene.

In another preferred form the stabilizer is a mixture of compound (5) and a hydroxyphenyl-triazine selected from compounds (10), (11) or (12), and the shaped polymer article is made of a polyolefin, such as a polyethylene, and where the weight ratio is from 20:1 to 1:1, or 20:1 to 5:1.

In another preferred form the stabilizer is a mixture of compound (7) and a hydroxyphenyl-triazine selected from compounds (10), (11) or (12), and the shaped polymer article is made of a polyolefin, such as a polyethylene, and where the weight ratio is from 20:1 to 1:1, or 20:1 to 5:1.

In another preferred form the stabilizer is a mixture of compound (5) and compound (11), and the shaped polymer article is made of a polyolefin, such as a polyethylene, and where the weight ratio is from 20:1 to 1:1, or 20:1 to 5:1.

In another preferred form the stabilizer is a mixture of compound (7) and compound (11), and the shaped polymer article is made of a polyolefin, such as a polyethylene, and where the weight ratio is from 20:1 to 1:1, or 20:1 to 5:1.

In another preferred form the stabilizer is a mixture of compound (8) and a hydroxyphenyl-triazine selected from compounds (10), (11) or (12), and the shaped polymer article is made of a polyolefin, such as a polypropylene.

In another preferred form the stabilizer is a mixture of compound (8) and compound (10), and the shaped polymer article is made of a polyolefin, such as a polypropylene.

In another preferred form the stabilizer is a mixture of compound (8) and compound (11), and the shaped polymer article is made of a polyolefin, such as a polypropylene.

In another preferred form the stabilizer is a mixture of compound (8) and a hydroxyphenyl-triazine selected from compounds (10), (11) or (12), and the shaped polymer article is made of a polyolefin, such as a polypropylene, and where the weight ratio is from 20:1 to 1:1, or 15:1 to 4:1.

In another preferred form the stabilizer is a mixture of compound (8) and compound (10), and the shaped polymer article is made of a polyolefin, such as a polypropylene, and where the weight ratio is from 20:1 to 1:1, or 15:1 to 4:1.

In another preferred form the stabilizer is a mixture of compound (8) and compound (11), and the shaped polymer article is made of a polyolefin, such as a polypropylene, and where the weight ratio is from 20:1 to 1:1, or 15:1 to 4:1.

In another preferred form the stabilizer is compound (2) and the shaped polymer article is made of a poly(methyl methacrylate).

In another preferred form the stabilizer is compound (3) and the shaped polymer article is made of a poly(methyl methacrylate).

In another preferred form the stabilizer is compound (4) and the shaped polymer article is made of a poly(methyl methacrylate).

In another preferred form the stabilizer is compound (6) and the shaped polymer article is made of a poly(methyl methacrylate).

In another preferred form the stabilizer is compound (2) and the shaped polymer article is made of a poly(methyl methacrylate) and the shaped polymer article comprises 0.1-5 wt %, preferably 0.3-3 wt % of the stabilizer.

In another preferred form the stabilizer is compound (3) and the shaped polymer article is made of a poly(methyl methacrylate) and the shaped polymer article comprises 0.1-5 wt %, preferably 0.3-3 wt % of the stabilizer.

In another preferred form the stabilizer is compound (4) and the shaped polymer article is made of a poly(methyl methacrylate) and the shaped polymer article comprises 0.1-5 wt %, preferably 0.3-3 wt % of the stabilizer. In another preferred form the stabilizer is compound (6) and the shaped polymer article is made of a poly(methyl methacrylate) and the shaped polymer article comprises 0.1-5 wt %, preferably 0.3-3 wt % of the stabilizer.

In another preferred form the stabilizer is a mixture of compound (2) and a hydroxyphenyl-triazine selected from compounds (10), (11) or (12), and the shaped polymer article is made of a poly(methyl methacrylate).

In another preferred form the stabilizer is a mixture of compound (3) and a hydroxyphenyl-triazine selected from compounds (10), (11) or (12), and the shaped polymer article is made of a poly(methyl methacrylate).

In another preferred form the stabilizer is a mixture of compound (4) and a hydroxyphenyl-triazine selected from compounds (10), (11) or (12), and the shaped polymer article is made of a poly(methyl methacrylate).

In another preferred form the stabilizer is a mixture of compound (6) and a hydroxyphenyl-triazine selected from compounds (10), (11) or (12), and the shaped polymer article is made of a poly(methyl methacrylate).

In another preferred form the stabilizer is a mixture of compound (2) and compound (11), and the shaped polymer article is made of a poly(methyl methacrylate).

In another preferred form the stabilizer is a mixture of compound (3) and compound (11), and the shaped polymer article is made of a poly(methyl methacrylate).

In another preferred form the stabilizer is a mixture of compound (4) and compound (11), and the shaped polymer article is made of a poly(methyl methacrylate).

In another preferred form the stabilizer is a mixture of compound (6) and compound (11), and the shaped polymer article is made of a poly(methyl methacrylate).

In another preferred form the stabilizer is a mixture of compound (2) and a hydroxyphenyl-triazine selected from compounds (10), (11) or (12), and the shaped polymer article is made of a poly(methyl methacrylate), and where the weight ratio is from 100:1 to 1:1, or 70:1 to 5:1, or 50:1 to 10:1.

In another preferred form the stabilizer is a mixture of compound (3) and a hydroxyphenyl-triazine selected from compounds (10), (11) or (12), and the shaped polymer article is made of a poly(methyl methacrylate), and where the weight ratio is from 100:1 to 1:1, or 70:1 to 5:1, or 50:1 to 10:1.

In another preferred form the stabilizer is a mixture of compound (4) and a hydroxyphenyl-triazine selected from compounds (10), (11) or (12), and the shaped polymer article is made of a poly(methyl methacrylate), and where the weight ratio is from 100:1 to 1:1, or 70:1 to 5:1, or 50:1 to 10:1.

In another preferred form the stabilizer is a mixture of compound (6) and a hydroxyphenyl-triazine selected from compounds (10), (11) or (12), and the shaped polymer article is made of a poly(methyl methacrylate), and where the weight ratio is from 100:1 to 1:1, or 70:1 to 5:1, or 50:1 to 10:1.

In another preferred form the stabilizer is a mixture of compound (2) and compound (11), and the shaped polymer article is made of a poly(methyl methacrylate), and where the weight ratio is from 100:1 to 1:1, or 70:1 to 5:1, or 50:1 to 10:1.

In another preferred form the stabilizer is a mixture of compound (3) and compound (11), and the shaped polymer article is made of a poly(methyl methacrylate), and where the weight ratio is from 100:1 to 1:1, or 70:1 to 5:1, or 50:1 to 10:1.

In another preferred form the stabilizer is a mixture of compound (4) and compound (11), and the shaped polymer article is made of a poly(methyl methacrylate), and where the weight ratio is from 100:1 to 1:1, or 70:1 to 5:1, or 50:1 to 10:1.

In another preferred form the stabilizer is a mixture of compound (6) and compound (11), and the shaped polymer article is made of a poly(methyl methacrylate), and where the weight ratio is from 100:1 to 1:1, or 70:1 to 5:1, or 50:1 to 10:1.

In another preferred form the stabilizer is compound (6) and the shaped polymer article is made of a polyurethane.

In another preferred form the stabilizer is compound (6) and the shaped polymer article is made of a polyurethane and the shaped polymer article comprises 0.1-5 wt %, preferably 0.3-3 wt % of the stabilizer.

In another preferred form the stabilizer is a mixture of compound (9) and a hydroxyphenyl-triazine selected from compounds (10), (11) or (12), and the shaped polymer article is made of a polyurethane.

In another preferred form the stabilizer is a mixture of compound (9) and compound (12), and the shaped polymer article is made of a polyurethane.

In another preferred form the stabilizer is a mixture of compound (9) and a hydroxyphenyl-triazine selected from compounds (10), (11) or (12), and the shaped polymer article is made of a polyurethane and where the weight ratio is from 20:1 to 1:1, or 10:1 to 1:1, or 8:1 to 2:1.

In another preferred form the stabilizer is a mixture of compound (9) and compound (12), and the shaped polymer article is made of a polyurethane and where the weight ratio is from 20:1 to 1:1, or 10:1 to 1:1, or 8:1 to 2:1.

In another preferred form the stabilizer is compound (2) and the shaped polymer article is made of a polyurethane.

In another preferred form the stabilizer is compound (2) and the shaped polymer article is made of a polyurethane and the shaped polymer article comprises 0.1-5 wt %, preferably 0.3-3 wt % of the stabilizer.

In another preferred form the stabilizer is a mixture of compound (2) and a hydroxyphenyl-triazine selected from compounds (10), (11) or (12), and the shaped polymer article is made of a polyurethane.

In another preferred form the stabilizer is a mixture of compound (2) and compound (10), and the shaped polymer article is made of a polyurethane.

In another preferred form the stabilizer is a mixture of compound (2) and compound (11), and the shaped polymer article is made of a polyurethane.

In another preferred form the stabilizer is a mixture of compound (2) and a hydroxyphenyl-triazine selected from compounds (10), (11) or (12), and the shaped polymer article is made of a polyurethane and where the weight ratio is from 20:1 to 1:1, or 15:1 to 1:1, or 10:1 to 2:1.

In another preferred form the stabilizer is a mixture of compound (2) and compound (10), and the shaped polymer article is made of a polyurethane and where the weight ratio is from 20:1 to 1:1, or 15:1 to 1:1, or 10:1 to 2:1.

In another preferred form the stabilizer is a mixture of compound (2) and compound (11), and the shaped polymer article is made of a polyurethane and where the weight ratio is from 20:1 to 1:1, or 15:1 to 1:1, or 10:1 to 2:1.

The shaped polymer article is for example prepared or shaped by one of the following processing steps:
Injection blow molding, extrusion, blow molding, rotomolding, in mold decoration (back injection), slush molding, injection molding, co-injection molding, blow molding, forming, compression molding, resin transfer molding, pressing, film extrusion (cast film; blown film), fiber spinning (woven, non-woven), drawing (uniaxial, biaxial), annealing, deep drawing, calendering, mechanical transformation, sintering, coextrusion, lamination, crosslinking (radiation, peroxide, silane), vapor deposition, weld together, glue, vulcanization, thermoforming, pipe extrusion, profile extrusion, sheet extrusion; sheet casting, strapping, foaming, recycling/rework, visbreaking (peroxide, thermal), fiber melt blown, spun bonded, surface treatment (corona discharge, flame, plasma), sterilization (by gamma rays, electron beams), tape extrusion, pulltrusion, SMC-process or plastisol.

The shaped polymer article can be an extruded, molded or calendered shaped polymer article.

The shaped polymer articles may have any shape, such as a film, foil, fiber, fabric, plate, device.

### EXAMPLES

### Example 1: Polypropylene Compression Molded Films

A PP/TPO (Borealis Daplen® EE013AE) was formulated with 0.1% of a blend of 80% tris (2,4-di-tert-butylphenyl)phosphite and 20% octadecyl-3-(3,5-di-tert-butyl-4-hydroxyphenyl)-propionate, 0.05% of calcium stearate and the additives listed in the Table 1. The formulation components listed were pre-mixed in a high-speed mixer. Thoroughly blended formulations were melt compounded in a Collin ZK25×42D twin screw extruder at set temperature of 230° C. and 160rpm under nitrogen. Pelletized samples were compression molded to a film of 170 micron thickness, in a press at 230° C. for 3 minutes.

UV-C Ageing Device: The samples were exposed to UV-C radiation in a climate chamber equipped with 2 stainless steel lamp racks holding 5 UVC 253.7 nm emitting lamps TUV T8 F17 1SL/25, from Signify GmbH, Hamburg, Germany. The sample holding racks were positioned 57 cm below the lamp racks and the samples were only placed in center of the sample rack (30×40 cm). The conditions in the chamber were maintained at a temperature of 65±3° C. and relative humidity of 20±10% r.h. The irradiance in the range of 250 to 260 nm measured at the level of the sample racks is 7.7 W/m².

The measured parameter was the change in intensity of the C═O absorption (carbonyl absorption) measured at 1721 cm⁻¹ with the FT-IR Spectrophotometer Nicolet IN10MX of Thermo Fisher Scientific Inc. The change in intensity of the carbonyl absorption was used to measure the oxidative damage in the sample. The times in hours to reach a carbonyl value of 0.1 are reported in the Table 1.

TABLE 1

| | | Time to reach |
|---|---|---|
| | | carbonyl |
| Sample | Additives | absorption = 0.1 |
| A | — (Comparative) | 18 h |
| B | 0.05% Compound (2) | 26 h |
| C | 0.10% Compound (2) | 36 h |

The data showed that the Samples B and C stabilized the polymer better against degradation induced by artificial UV-C light compared to the Sample A.

### Example 2: ABS Compression Molded Plaques

An ABS (acrylonitrile butadiene styrene copolymer, Terluran GP-22 from INEOS Styrolution, 100 wt %) was formulated with 0.1 wt % of a blend of 80% tris(2,4-di-tert-butylphenyl)phosphite and 20% octadecyl-3-(3,5-di-tert-butyl-4-hydroxyphenyl)-propionate, and in Samples B to E 0.03 wt % of the hindered amine light stabilizer (N,N′-bis(2,2,6,6-tetramethyl-4-piperidyl)-N,N′-diformylhexamethylenediamine, CAS 124172-53-8), and the additives listed in Table 2. Compound (13) is 2-(2-Hydroxy-5-methylphenyl)benzotriazole CAS 2440-22-4.

Thoroughly blended formulations were dried for 3 hours in a vacuum oven at 80° C. prior to melt compounding in a Collin ZK25×42D twin-screw extruder at set temperature of 220° C. and 160 rpm under nitrogen. Pelletized samples were dried for 3 hours at 80° C. and compression molded to 2 mm thick plaques (50×75 mm) in a press at 220° C. for 3 minutes.

The plaques were exposed to UV-C ageing device as described in Example 1. The plaques were tested for change in color (Delta E) with increasing exposure time according to DIN EN ISO/CIE 11664-4 with a Datacolor 800 spectrophotometer; aperture of 20 mm The Delta E values after 12 hours and 18 hours of exposure are summarized in the Table 2.

TABLE 2

| | | Delta E | Delta E |
|---|---|---|---|
| | | after | after |
| | | 12 hrs | 18 hrs |
| A | — (comparative) | 5.1 | 7.2 |
| B | 0.05% Compound (2) + 0.03% Compound (13) | 4.1 | 6.2 |
| C | 0.05% Compound (4) + 0.03% Compound (13) | 4.2 | 6.3 |
| D | 0.05% Compound (1) + 0.03% Compound (13) | 4.4 | 6.5 |
| E | 0.05% Compound (6) + 0.03% Compound (13) | 4.4 | 6.6 |

The data showed that the Samples B to E stabilized the polymer better against degradation induced by artificial UV-C light compared to the Sample A.

### Example 3: LDPE Blown Film

A Low Density Polyethylene Riblene FC 30 of 0.922 g/cm³ density (ISO 1183) and Melt Index of 0.25 g/10 min @ 190° C./2.16 kg (ISO 1133) was formulated with formulated with 1000 ppm of the oligomeric hindered amine light stabilizer (butanedioic acid, dimethylester, polymer with 4-hydroxy-2,2,6,6-tetramethyl-1-piperidine ethanol, CAS 65447-77-0) and the additives listed in Table 3.

Additive loadings are in ppm (parts per million) by weight, based on the weight of the polymer. All formulations contained additionally 2000 ppm erucamide (Crodamide ER-MB-GD) and 1000 ppm of a blend of 80% tris(2,4-di-tert-butylphenyl)phosphite and 20% octadecyl-3-(3,5-di-tert-butyl-4-hydroxyphenyl)-propionate as antioxidants.

Additives were blended with grinded polymer powder in a high-speed mixer. Thoroughly blended formulations were melt compounded in a Berstorff ZE25A×47D twin-screw extruder at maximum 200° C., 160rpm under nitrogen. Pelletized samples were processed on laboratory blown film line (Dolci) with a 100 mm die and set temperature of 180° C. into 100 micron thick mono layer films.

The film samples were exposed to UVC aging device as described in Example 1.

The change in intensity of the C═O absorption (carbonyl absorption) in the IR-spectrum was used to measure the oxidative damage of the polyethylene film sample. The spectra were measured at 1721 cm⁻¹ with the FT-IR Spectrophotometer Nicolet IN10MX of Thermo Fisher Scientific Inc. The times in hours to reach a carbonyl value of 0.1 are reported in the Table 3.

TABLE 3

| | | time to reach carbonyl |
|---|---|---|
| Sample | Additives | absorption = 0.1 |
| A | — (Comparative) | 285 |
| B | 0.12% Compound (8) (Comparative) | 328 |
| C | 0.09% Compound (8) | 365 |
| | 0.03% Compound (11) | |
| D | 0.09% Compound (8) | 420 |
| | 0.03% Compound (10) | |

The data showed that the Samples C and D with lower amount of Compound (8) stabilized the polymer better against degradation induced by artificial UV-C light compared to the Sample A and even B with a higher amount of the Compound (8).

### Example 4: LDPE Blown Film

A Low Density Polyethylene (Riblene FC 30 of 0.922 g/cm³ density (ISO 1183) and Melt Index of 0.25 g/10 min @ 190° C./2.16 kg (ISO 1133)) was formulated with 3000 ppm of the block oligomeric hindered amine light stabilizer (1,6-Hexanediamine, N,N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine, CAS 192268-64-7, and the additives listed in the Table 4.

Additive loadings are in ppm (parts per million) by weight, based on the weight of the polymer.

Additives were blended with grinded polymer powder in a high-speed mixer. Thoroughly blended formulations were melt compounded in a Berstorff ZE25A×47D twin-screw extruder at maximum 200° C., 160 rpm under nitrogen. Pelletized samples were processed on laboratory blown film line (Collin BL), with a 80 mm die and a set temperature of 210° C. into a 5 layers 100 micron thick films (30/5/30/5/30).

The film samples were exposed to UV-C ageing device as described in Example 1.

The change in intensity of the C═O absorption (carbonyl absorption) in the IR-spectrum was used to measure the oxidative damage of the polyethylene film sample. The spectra were measured at 1721 cm⁻¹ with the FT-IR Spectrophotometer Nicolet IN10MX of Thermo Fisher Scientific Inc. The times in hours to reach a carbonyl value of 0.1 are reported in the Table 4.

TABLE 4

| | | time to reach |
|---|---|---|
| | | carbonyl |
| Sample | Additives | absorption = 0.1 |
| A | — (comparative) | 211 h |
| B | 0.1% Compound (4) | 291 h |
| C | 0.1% Compound (3) | 271 h |
| D | 0.1% Compound (7) | 223 h |
| E | 0.036% Compound (7) | 239 h |
| | 0.004% Compound (11) | |
| F | 0.1% Compound (5) | 218 h |
| G | 0.036% Compound (5) | 220 h |
| | 0.004% Compound (11) | |

The data showed that the Samples B, C, D, and F stabilized the polymer better against degradation induced by artificial UV-C light compared to the Sample A.

The data showed that the Sample E with lower amount of Compound (7) stabilized the polymer better against degradation induced by artificial UV-C light compared to the Sample A and even D with a higher amount of the Compound (7).

The data showed that the Sample G with lower amount of Compound (5) stabilized the polymer better against degradation induced by artificial UV-C light compared to the Sample A and even F with a higher amount of the Compound (5).

### Example 5: Polypropylene Compression Molded Plaques

A polypropylene homopolymer (Moplen HP500N) was formulated with 0.1% 1,3,5-tris(3,5-di-tert-butyl-4-hydroxybenzyl)-1,3,5-triazine-2,4,6 (1H,3H,5H)-trione (CAS 27676-62-6), 0.1% tris(2,4-di-tert.-butylphenyl) phosphite, 0.145 1,6-Hexanediamine, N,N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine (CAS 192268-64-7), and 0.07% N,N′-bis(2,2,6,6-tetramethyl-4-piperidyl)-N,N′-diformylhexamethylenediamine, CAS 124172-53-8, and the additives in Table 5.

The formulation components listed were pre-mixed in a high-speed mixer. Thoroughly blended formulations were melt compounded in a Collin ZK25×42D twin-screw extruder at set temperature of 230° C. and 160rpm under nitrogen. Pelletized samples were injection molded to 1 mm thick plaques (90×85 mm) in an Arburg 320 S injection molding machine at 230° C.

The plaques were exposed to UV-C ageing device as described in Example 1.

The change in intensity of the C═O absorption (carbonyl absorption) in the IR-spectrum was used to measure the oxidative damage of the polyethylene film sample. The spectra were measured at 1721 cm⁻¹ with the FT-IR Spectrophotometer Nicolet IN10MX of Thermo Fisher Scientific Inc. The times in hours to reach a carbonyl value of 0.1 are reported in the Table 5.

TABLE 5

| | | time to reach |
|---|---|---|
| | | Carbonyl |
| Sample | Additives | absorption = 0.1 |
| A | 0.05% Compound (8) (comparative) | 330 h |
| B | 0.044% Compound (8) | 344 h |
| | 0.006% Compound (11) | |
| C | 0.044% Compound (8) | 356 h |
| | 0.006% Compound (10) | |

The data showed that the Samples B and C (all with lower amount of Compound (8)) stabilized the polymer better against degradation induced by artificial UV-C light compared to the Sample A with a higher amount of the Compound (8).

### Example 6: PMMA Solution Cast Films

Film preparation was made as follows: 10 g of an amorphous thermoplastic polymethylmethacrylate (Plexiglas® 7N) were dissolved in 40g of methylene chloride together with 0.1 g of 1,6-Hexanediamine, N,N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine (CAS 192268-64-7) as base stabilization for the integrity of the prepared film, and 0.103 g of the compounds listed in the Table 6.

Films were drawn with the help of an automatic Blade (Erichsen) with a blade speed of 12 mm/sec and a gap of height of 120 mm.

The films were exposed to UV-C ageing device as described in Example 1. The times in hours to embrittlement of the films are reported in the Table 6.

TABLE 6

| | | Hours to |
|---|---|---|
| Sample | Additives | embrittlement |
| A | 1.03% Compound (3) | 6 |
| B | 1% Compound (3) | 10 |
| | 0.03% Compound (11) | |
| C | 1.03% Compound (2) | 10 |
| D | 1% Compound (2) | 10 |
| | 0.03% Compound (11) | |
| E | 1.03% Compound (4) | 10 |
| F | 1% Compound (4) | 18 |
| | 0.03% Compound (11) | |
| G | 1.03% Compound (6) | 6 |
| H | 1% Compound (6) | 6 |
| | 0.03% Compound (11) | |

The data showed that the Samples A, C, E, and G stabilized the polymer against degradation induced by artificial UV-C light.

The data also showed that the Samples B, D, F and H (all with lower amount of the first additive) stabilized the polymer better against degradation induced by artificial UV-C light compared to the Sample A, C, E, and G, respectively, with a higher amount of the first additive.

### Example 7: TPU Plaques

An aromatic thermoplastic polyurethane TPU (Desmopan® 385S from Covestro) was formulated with 0.27% ethylene bis (oxyethylene) bis-(3-(5-tert-butyl-4-hydroxy-m-tolyl)-propionate) (CAS 36443-68-2), 0.17% bis-(2,4-di-tert.-butylphenol)pentaerythritol diphosphite, 0.8% butanedioic acid, dimethylester, polymer with 4-hydroxy-2,2,6,6-tetramethyl-1-piperidine ethanol (CAS 65447-77-0) and the additives listed in the Table 7.

The polymer was dried at 80° C. under nitrogen blanket and vacuum prior to the mixing to a level below 0.05% of water. The formulation components listed were pre-mixed in a high-speed mixer. Thoroughly blended formulations were directly melt compounded in a Berstorff ZE25A×47D twin-screw extruder at set temperature of 210° C. and 160rpm under nitrogen. Pelletized samples were dried with air for 4 hours at 80° C. (water content below 0.03%) and injection molded to 2 mm thick plaques (44×68 mm) in an Engel e-mac 100 injection molding machine at 210° C.

The plaques are exposed to UV-C ageing device as described in Example 1. The times in hours to Delta E value=12 of the plaques are reported in the Table 7.

TABLE 7

| | | Hours to |
|---|---|---|
| Sample | Additives | Delta E = 12 |
| A | 1.0% Compound (9) (comparative) | 130 |
| B | 1.0% Compound (9) | 142 |
| | 0.2% Compound (12) | |
| C | 1.0% Compound (6) | 146 |

The data showed that the Sample B stabilized the polymer better against degradation induced by artificial UV-C light compared to the Sample A.

The data showed that the Sample C stabilized the polymer better against degradation induced by artificial UV-C light compared to the Sample A.

### Example 8: TPU Plaques

An aromatic TPU (Elastollan® 1185 A 10 000 from BASF) was formulated with 1.0% of butanedioic acid, dimethylester, polymer with 4-hydroxy-2,2,6,6-tetramethyl-1-piperidine ethanol (CAS 65447-77-0) and the additives listed in the Table 8.

The polymer was dried at 80° C. under nitrogen blanket and vacuum prior to the mixing to a level below 0.02% of water. The formulation components listed were pre-mixed in a high-speed mixer. Thoroughly blended formulations were directly melt compounded in a Berstorff ZE25A×47D twin-screw extruder at set temperature of 205° C. and 160rpm under nitrogen. Pelletized samples were dried with air for 4 hours at 80° C. (water content below 0.02%) and injection molded to 2 mm thick plaques (44×68 mm) in an Engel e-mac 100 injection molding machine at 210° C.

The plaques were exposed to UV-C ageing device as described in Example 1. The times in hours to Delta E value=12 of the plaques are reported in the Table 8.

TABLE 8

| | | Hours to |
|---|---|---|
| Sample | | Delta E = 12 |
| A | 1.0% Compound (2) | 172 |
| B | 0.8% Compound (2) | 173 |
| | 0.2% Compound (10) | |
| C | 0.8% Compound (2) | 181 |
| | 0.2% Compound (11) | |
| D | 0.9% Compound (2) | 189 |
| | 0.1% Compound (11) | |

The data showed that the Sample A stabilized the polymer against degradation induced by artificial UV-C light.

The data showed that the Samples B, C and D (all with lower amounts of Compound (2)) stabilized the polymer even better against degradation induced by artificial UV-C light compared to the Sample A with a higher amount of Compound (2).

1. A method for stabilizing a shaped polymer article against degradation induced by artificial UV-C light, comprising incorporating into the shaped polymer article a stabilizer selected from: 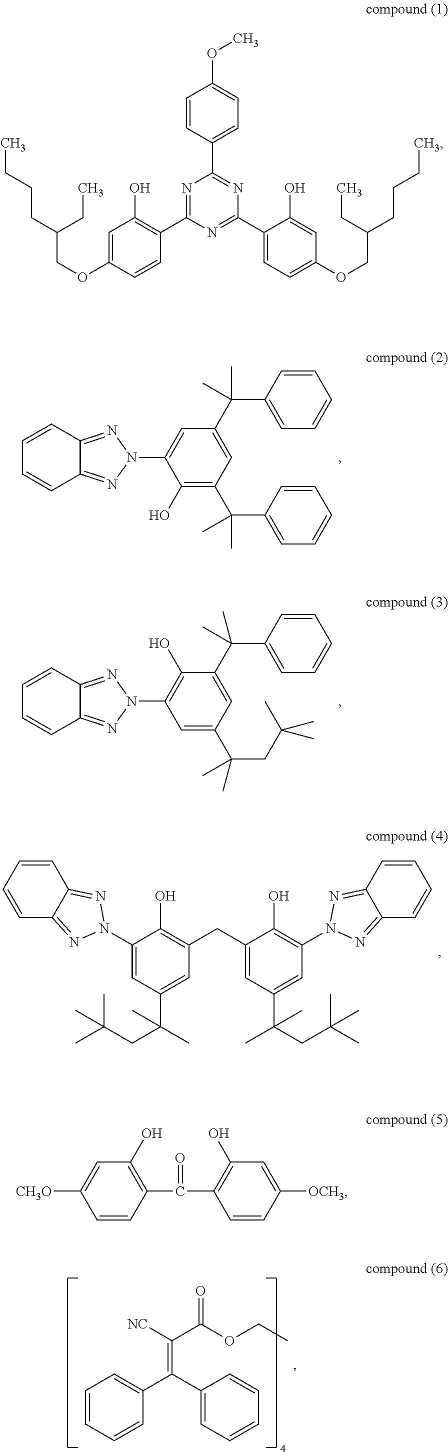 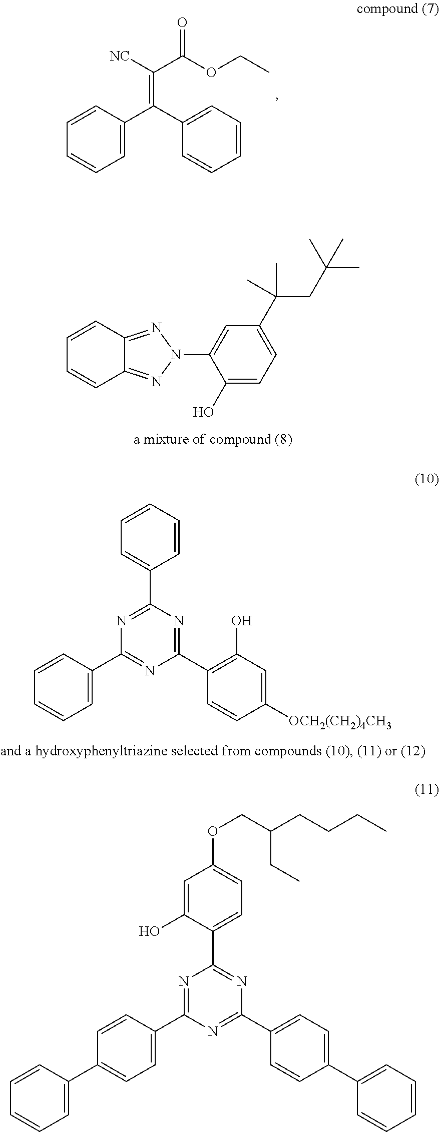 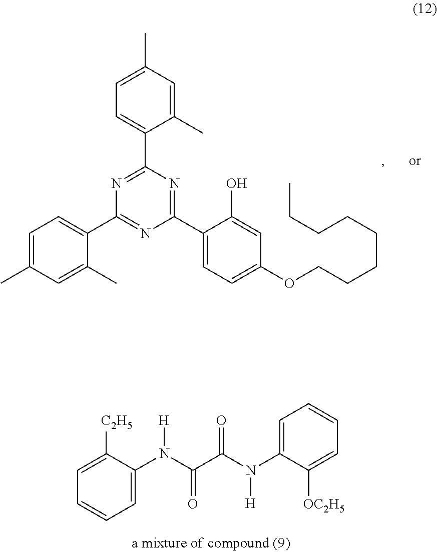 [SMILES: CCCCCCCCOc1ccc(-c2nc(-c3ccc(C)cc3C)nc(-c3ccc(C)cc3C)n2)c(O)c1 ; CCOc1ccccc1NC(=O)C(=O)Nc1ccccc1CC]
and a hydroxyphenyltriazine selected from compound (10), (11) or (12).

2. The method according to claim 1, wherein the degradation by UV-C light is induced frequently.

3. The method according to claim 1, wherein the stabilizer is present inside the shaped polymer article.

4. The method according to claim 1, wherein the UV-C light has a wavelength from 200 to 275 nm.

5. The method according to claim 1, wherein the degradation by UV-C light is induced indoors.

6. The method according to claim 1, wherein the shaped polymer article comprises 0.01-5 wt %.

7. The method according to claim 1, wherein the shaped polymer article is made of a synthetic polymer.

8. The method according to claim 1, wherein the weight ratio of the compound (8) or compound (9) to the hydroxyphenyltriazine selected from compound (10), (11) or (12) is from 100:1 to 1:3.

9. The method according to claim 1, wherein the degradation by UV-C light is induced by UV-C disinfection against microorganism of the shaped polymer article.

10. The method according to claim 1, wherein a dose of at least 100 μW·s/cm² within 24 h is received at the surface of the shaped polymer article.

11. The method according to claim 1, wherein the shaped polymer articles is a film, foil, fiber, fabric, plate, or device.

12. The method according to claim 1, wherein a non-porous surface of the shaped polymer article is stabilized against the degradation.

13. The method according to claim 1, wherein a non-transparent surface of the shaped polymer article is stabilized against the degradation.

14. (canceled)

15. The method according to claim 1, wherein the degradation by UV-C light is induced at least once a week.

16. The method according to claim 1, wherein the degradation by UV-C light is induced in public buildings, industrial offices, industrial production buildings, private buildings, or in transport vehicles.

17. The method according to claim 1, wherein the shaped polymer article comprises 0.1-3 wt % of each of the stabilizers.

18. The method according to claim 1, wherein the shaped polymer article is made of polyethylenes, polypropylenes, polystyrenes, acrylonitrile butadiene styrene copolymer, polycarbonates, polyvinyl chlorides, polyamides, polyurethanes, poly(methyl methacrylates), and/or polyethylene terephthalates.

19. The method according to claim 1, wherein the weight ratio of the compound (8) or compound (9) to the hydroxyphenyltriazine selected from compound (10), (11) or (12) is from 50:1 to 2:1.

20. The method according to claim 1, wherein the stabilizer is evenly distributed inside the shaped polymer article.
